(19) United States
(12) Patent Application Publication
(10) Pub. No.: US 2016/0114295 A1
(43) Pub. Date: Apr. 28, 2016

(54) METHOD FOR MANUFACTURING ASYMMETRIC POLYVINLYLIDENEFLUORIDE HOLLOW FIBER MEMBRANE AND HOLLOW FIBER MEMBRANE MANUFACTURED THEREFROM

(71) Applicant: ECONITY CO., LTD., Gyeonggi-do (KR)

(72) Inventors: Min-Soo PARK, Gyeonggi-do (KR); Jin-Ho KIM, Gyeonggi-do (KR)

(21) Appl. No.: 14/895,821

(22) PCT Filed: Aug. 12, 2013
(86) PCT No.: PCT/KR2013/007250

§ 371 Date: Dec. 3, 2015

(30) Foreign Application Priority Data
Jun. 4, 2013 (KR) 10-2013-0064164

(51) Int. Cl. B01D 67/00; B29B 9/12; B29C 47/00; B01D 69/08; B01D 71/34

(52) U.S. Cl. CPC B01D 67/0018; B01D 69/087; B01D 71/34; B29C 47/0014; B29C 47/0026; B29C 47/0038; B29B 9/12; B29C 47/0057; B29C 47/0066; B01D 2323/08; B01D 2323/28; B01D 2325/022; B29K 2027/16

(57) ABSTRACT

The present disclosure relates to a method for manufacturing an asymmetric polyvinlylidene fluoride (PVDF) hollow fiber membrane, whereby a PVDF hollow fiber membrane is manufactured by the thermally induced phase separation method, which enables effective mixing of the PVDF and a diluent without additional use of an inorganic fine powder such as silica and is advantageous in that it is relatively easy to control preparation parameters because temperature is the main factor of phase separation of the two-component system of the polymer and the diluent and thus to obtain a separation membrane of satisfactory quality, by providing temperature difference between the inner and outer surfaces of a hollow fiber, thereby achieving an asymmetric structure in which the inner surface side and the outer surface side of the hollow fiber have different pore sizes and distributions.

### FIELD

The present application claims priority to Korean Patent Application No. 10-2013-0064164 filed on Jun. 4, 2013 in the Republic of Korea, the disclosures of which are incorporated herein by reference.

The present disclosure relates to an effective method for manufacturing an asymmetric polyvinlylidene fluoride (PVDF) hollow fiber membrane, whereby a pellet of PVDF and a diluent is prepared to enable effective mixing of the PVDF and the diluent without additional use of an inorganic fine powder such as silica and phase separation of the PVDF and the diluent is thermally induced by providing temperature difference between the inner and outer surfaces of a hollow fiber during spinning, thereby achieving an asymmetric structure in which the inner surface side and the outer surface side of the hollow fiber have different pore sizes and distributions. The present disclosure also relates to an asymmetric PVDF hollow fiber membrane having a pore symmetry index, defined as the ratio the pore area on the outer surface and the pore area on the inner surface, of 0.1-0.8 and having superior water permeability and tensile strength unlike a PVDF separation membrane manufactured by the existing method.

### BACKGROUND

A separation membrane is usually in the form of a flat membrane or a hollow fiber membrane. To obtain the flat membrane or hollow fiber membrane, a polymer should be prepared into a liquid state first. To prepare a polymer into a liquid state, the polymer may be melt by heating above its melting point or it may be dissolved at room temperature using a solvent. When there is no special solvent that can dissolve the polymer at room temperature, the polymer is mixed with a diluent, a plasticizer, etc. having appropriate compatibility with the polymer at high temperature and then melt by heating to shape it into a flat membrane or a hollow fiber membrane.

The nonsolvent induced phase separation (NIPS) method of preparing a separation membrane by dissolving a polymer using a solvent and then contacting with a nonsolvent is the most traditional method of separation membrane preparation. However, this method cannot be employed if there is no special solvent that can dissolve the polymer at room temperature and the product quality may be unsatisfactory because macropores may be formed at the sites where the solvent has been present after the solvent is removed. In addition, when removing the solvent using the nonsolvent, a lot of preparation parameters should be considered and control of the three-component interaction among the polymer, the solvent and the nonsolvent is difficult. Accordingly, it is not easy to obtain a separation membrane of satisfactory quality.

In contrast, in the thermally induced phase separation (TIPS) method, a uniform mixture is prepared by stirring a polymer and a diluent at high temperature, which is passed through a die having a specific shape and then cooled to shape it into a flat membrane or a hollow fiber membrane. Finally, the diluent is extracted to obtain the final separation membrane. Therefore, the associated system is a two-component system of the polymer and the diluent and temperature is the main factor of phase separation. Accordingly, it is relatively easy to control the preparation parameters and obtain a separation membrane of satisfactory quality.

The common feature of the nonsolvent induced phase separation (NIPS) method and the thermally induced phase separation (TIPS) method is that pores are formed by removing the solvent or the diluent from a uniform mixture of the polymer and the solvent or the diluent. For uniform mixing of the polymer and the solvent or the diluent, the compatibility between the polymer and the solvent or the diluent is important. For the polymer and the solvent are used, the polymer is dissolved by the solvent. However, for uniform mixing and dispersion of the polymer and the diluent, high-temperature heat should be applied and they should be compatible with each other. Traditionally, a PVDF separation membrane has been prepared by the nonsolvent induced phase separation of dissolving PVDF using a solvent such as dimethylacetamide (DMAC), N-methylpyrrolidone (NMP), etc. and then replacing the solvent with a nonsolvent. However, there have been disadvantages in that mechanical properties are unsatisfactory due to generation of macrovoids, pinhole, etc. and low PVDF content and it is difficult to predict the phase transition of the three-component system due to the introduction of the nonsolvent for separating the PVDF from the solvent.

Some diluents which lack compatibility with PVDF at room temperature, such as dimethyl phthalate (DMP), diethyl phthalate (DEP), dibutyl phthalate (DBP), etc., gain compatibility when stirred at high temperature. Therefore, the thermally induced phase separation (TIPS) method of preparing a separation membrane by inducing complete mixing at high temperature, conducting phase separation at low temperature and then extracting and removing the diluent is studied a lot as a solution to the problems of the nonsolvent induced phase separation (NIPS) method.

In the thermally induced phase separation method wherein phase separation of a mixture of PVDF and a diluent having compatibility at high temperature is induced by cooling, as shown in the phase diagram of FIG. 1 (the abscissa φ represents the mixing ratio of the PVDF and the diluent and the ordinate T represents the temperature of the mixture), as the temperature is lowered, phase separation occurs via two mechanisms depending on the mixing ratio of the mixture, i.e., from a one-phase region 1 through a crystallization curve 4 to a liquid-liquid phase separation region 3 or a solid-liquid phase separation region 2. The phase separation through the liquid-liquid phase separation region occurs only for some types of diluents. In particular, some diluents such as dioctyl phthalate (DOP) are not mixed with PVDF even at temperatures much higher than the melting temperature of PVDF, 174° C., and the PVDF and the diluent are present as melted but separated from each other at temperatures above 174° C., like oil and water. In addition, in the phase separation mechanism occurring through the liquid-liquid phase separation region, the phase separation behavior of the mixture may be different depending on the rate of cooling, i.e., rapid cooling (quenching) 6 or slow cooling 5.

WO 2002/70115A discloses a method for producing a hollow fiber membrane using the thermally induced phase separation (TIPS) method, wherein hydrophobic silica as an inorganic fine powder is mixed with a diluent lacking compatibility with PVDF in order to uniformly disperse it and the mixture is mixed again with PVDF, melt-kneaded through a twin-screw extruder, spun and then cooled to obtain a hollow fiber membrane precursor. During the process in which the hydrophobic silica and the diluent are removed from the obtained hollow fiber membrane precursor through repeated extraction, voids or pores are formed at the sites where the hydrophobic silica and the diluent have been. As a result, the hollow fiber membrane has a symmetric structure in which the inner surface and the outer surface have the same pore size and distribution.

As another existing art, US005698101A also describes a method for producing a hollow fiber membrane using the thermally induced phase separation (TIPS) method. In this patent, instead of using an inorganic fine powder, complicated nozzle and die are used to retain a mixture of a polymer and a diluent in the unstable liquid-liquid phase separation region in the phase diagram for sufficient time. Pores are formed during the process in which the diluent is extracted and removed from the mixture of the polymer and the diluent and the obtained hollow fiber membrane also has a symmetric structure having the same pore size and distribution on the inner surface and the outer surface.

As another existing art, KR2003-0001474 discloses a method for producing a PVDF hollow fiber membrane, which includes forming a hollow fiber by melt-kneading and extruding a mixture of PVDF and an organic liquid or a mixture containing PVDF, an organic liquid and an inorganic fine powder and extracting the organic liquid and the inorganic fine powder from the hollow fiber, wherein the method further includes drawing the hollow fiber before or after the extraction hollow fiber and then allowing it to shrink.

The PVDF hollow fiber membranes prepared according to the existing art are disadvantages in that they are symmetric hollow fiber membranes having the same pore size and distribution inside and outside the hollow fiber, an apparatus with a long kneading zone should be used to ensure sufficient stirring time when an extruder is used for uniform mixing in order to overcome the low compatibility between the PVDF and the diluent, and reliability of kneading of the PVDF and the diluent should be ensured through, for example, quantitative feeding of the raw materials to the extruder. In addition, there are disadvantages in that it is necessary to extract the inorganic fine powder such as hydrophobic silica added for effective mixing of the diluent and drawing and shrinking processes are necessary.

### DISCLOSURE

### Technical Problem

The present disclosure relates to a method for manufacturing an asymmetric polyvinlylidene fluoride (PVDF) hollow fiber membrane, whereby a PVDF hollow fiber membrane is manufactured by the thermally induced phase separation method, which enables effective mixing of the PVDF and a diluent without additional use of an inorganic fine powder such as silica and is advantageous in that it is relatively easy to control preparation parameters because temperature is the main factor of phase separation of the two-component system of the polymer and the diluent and thus to obtain a separation membrane of satisfactory quality, by providing temperature difference between the inner and outer surfaces of a hollow fiber, thereby achieving an asymmetric PVDF hollow fiber membrane having an asymmetric structure in which the inner surface side and the outer surface side of the hollow fiber have different pore sizes and distributions, having a pore symmetry index, defined as the ratio the pore area on the outer surface and the pore area on the inner surface, of 0.1-0.8 and exhibiting high porosity and water permeability due to large average pore size even after extraction and drawing processes as compared to the existing hollow fiber membrane because no inorganic fine powder is included.

### Technical Solution

In one aspect of the present disclosure, there is provided a method for manufacturing an asymmetric PVDF hollow fiber membrane, which includes (S1) a step of preparing a pellet by uniformly mixing a PVDF-based resin and a diluent in a batch reactor, (S2) a step of preparing a melted mixture containing the PVDF-based resin and the diluent by melting the pellet, (S3) a step of forming an unsolidified PVDF hollow fiber by spinning the melted mixture through a dual nozzle, (S4) a step of inducing thermally induced phase separation by providing temperature difference between the inner and outer surfaces of the spun unsolidified PVDF hollow fiber by supplying nitrogen gas at higher temperature than the outer surface to the inner surface and quenching the outer surface using a cooling medium at lower temperature than the inner surface and (S5) a step of forming pores inside the hollow fiber by extracting the diluent from the thermally phase separation induced PVDF hollow fiber precursor. The method may further include, before or after the step (S5) of forming the pores, (S6) a step of enlarging the pores inside the hollow fiber and newly forming pores outside the hollow fiber by drawing the PVDF hollow fiber membrane precursor.

In the step of preparing the pellet, an inorganic particle such as hydrophobic silica may not be used. Accordingly, production cost may be reduced and a process for removing an inorganic particle from the final PVDF hollow fiber membrane may be omitted. In addition, an asymmetric PVDF hollow fiber membrane exhibiting high tensile strength as well as high porosity and water permeability due to large average pore size even after extraction and drawing processes as compared to the existing hollow fiber membrane may be manufactured.

### Advantageous Effects

The present disclosure is advantageous in that a polyvinlylidene fluoride (PVDF) hollow fiber membrane manufactured by the thermally induced phase separation method, which enables effective mixing of the PVDF and a diluent without additional use of an inorganic fine powder such as silica, has an asymmetric structure in which the inner surface side and the outer surface side of the hollow fiber have different pore sizes and distributions, has a pore symmetry index, defined as the ratio the pore area on the outer surface and the pore area on the inner surface, of 0.1-0.8 and exhibits high porosity and water permeability due to large average pore size even after extraction and drawing processes as compared to the existing hollow fiber membrane because no inorganic fine powder is included. Also, there is an advantage that it is relatively easy to control preparation parameters because temperature is the main factor of phase separation of the two-component system of the polymer and the diluent and thus to obtain a separation membrane of satisfactory quality. In addition, even though the PVDF hollow fiber membrane precursor is stretched by the drawing, its thickness does not decrease significantly because the pores inside the hollow fiber are enlarged and fill the inner space. Accordingly, in accordance with the method for manufacturing a PVDF hollow fiber membrane according to the present disclosure, manufacturing cost per unit membrane area can be reduced.

### DESCRIPTION OF DRAWINGS

Other objects and aspects of the present disclosure will become apparent from the following descriptions of the embodiments with reference to the accompanying drawings in which:

FIG. 1 is a phase diagram showing the phase separation behavior of a melted mixture of PVDF and a diluent depending on mixing ratio and temperature.

FIG. 2 schematically shows an apparatus for manufacturing a PVDF hollow fiber membrane according to the present disclosure.

FIG. 3 schematically shows the formation of an asymmetric PVDF hollow fiber membrane having asymmetric pore sizes and distributions from a PVDF hollow fiber prepared from a mixture of PVDF and a diluent by thermally induced phase separation according to the present disclosure before (a) and after (b) drawing.

FIG. 4 schematically shows the mechanism of crack and pore formation during drawing of a PVDF hollow fiber precursor according to the present disclosure.

FIG. 5 schematically shows a batch jig drawing method according to the present disclosure.

FIG. 6 schematically shows a continuous roller drawing method according to the present disclosure.

FIG. 7 schematically shows the cross section of a hollow fiber in a thickness direction during a batch jig drawing method according to the present disclosure.

FIG. 8 schematically shows the deformation of a hollow fiber in a thickness direction during a continuous roller drawing method according to the present disclosure.

FIG. 9 schematically shows a PVDF hollow fiber membrane precursor wound around a cylindrical bobbin according to the present disclosure.

FIG. 10 schematically shows a PVDF hollow fiber membrane precursor wound around a hexahedral bobbin according to the present disclosure.

FIG. 11 shows scanning electron microscopic (SEM) images of the outer surface (left image) and the inner surface (right image) of a PVDF hollow fiber membrane precursor according to an exemplary embodiment of the present disclosure.

FIG. 12 shows scanning electron microscopic (SEM) images of the outer surface (left image) and the inner surface (right image) of a PVDF hollow fiber membrane manufactured from a PVDF hollow fiber membrane precursor through diluent extraction and drawing processes according to another exemplary embodiment of the present disclosure.

FIG. 13 shows scanning electron microscopic (SEM) images of the outer surface (left image) and the inner surface (right image) of a PVDF hollow fiber membrane manufactured from a PVDF hollow fiber membrane precursor through diluent extraction and drawing processes according to another exemplary embodiment of the present disclosure.

FIG. 14 shows the water permeability and tensile strength of a PVDF hollow fiber membrane according to an exemplary embodiment of the present disclosure depending on drawing ratio.

FIG. 15 shows the water permeability and tensile strength of a PVDF hollow fiber membrane prepared by the existing NIPS method depending on drawing ratio.

FIG. 16 shows the water permeability and tensile strength of a PVDF hollow fiber membrane prepared by the existing TIPS method depending on drawing ratio.

FIG. 17 shows scanning electron microscopic (SEM) images of the outer surface (left image) and the inner surface (right image) of a PVDF hollow fiber membrane manufactured from a PVDF hollow fiber membrane precursor through diluent extraction and drawing processes according to another exemplary embodiment of the present disclosure.

FIG. 18 shows scanning electron microscopic (SEM) images of the outer surface (left image) and the inner surface (right image) of a PVDF hollow fiber membrane manufactured by the existing NIPS method.

FIG. 19 shows scanning electron microscopic (SEM) images of the outer surface (left image) and the inner surface (right image) of a PVDF hollow fiber membrane manufactured by the existing TIPS method.

Description of Main Elements

| 100: apparatus for manufacturing PVDF hollow fiber membrane | |
|---|---|
| 110: batch reactor | |
| 111: main body | 112: heater |
| 113: stirrer | 114: gear pump |
| 115: nozzle | 120: gas storage tank |
| 130: solidification tank | F₁: thread |
| R₂, R₃: roller | 140: drawer |
| 150: air blower | 160: pelletizer |
| C: cutter | P: pellet |
| 170: extruder | |
| F₂: PVDF hollow fiber membrane precursor | |
| 171: hopper | 172: extrusion cylinder |
| 173: gear pump | 174: spinneret |
| NZ: dual spinning nozzle | 180: cooling chamber |
| 181: baffle | 182: supply pump |
| 183: suction pump | 184: condenser |
| NC: non-crystallization region | C: crystallization region |
| CR: crack | Z₁, Z₂: jig |
| W: wall | |
| F₂: PVDF hollow fiber membrane precursor | |
| F3: PVDF hollow fiber membrane | |
| R₄ₐ, R_{4b}: roller | CB: cylindrical bobbin |
| PB: hexahedral bobbin | |

### BEST MODE

Hereinafter, a method for manufacturing an asymmetric PVDF hollow fiber membrane according to the present disclosure is described in detail.

The method for manufacturing an asymmetric PVDF hollow fiber membrane according to the present disclosure includes (S1) a step of preparing a pellet by uniformly mixing a PVDF-based resin and a diluent in a batch reactor, (S2) a step of preparing a melted mixture containing the PVDF-based resin and the diluent by melting the pellet, (S3) a step of forming an unsolidified PVDF hollow fiber by spinning the melted mixture through a dual nozzle, (S4) a step of inducing thermally induced phase separation by providing temperature difference between the inner and outer surfaces of the spun unsolidified PVDF hollow fiber by supplying nitrogen gas at higher temperature than the outer surface to the inner surface and quenching the outer surface using a cooling medium at lower temperature than the inner surface and (S5) a step of forming pores inside the hollow fiber by extracting the diluent from the thermally phase separation induced PVDF hollow fiber precursor. The method may further include, before or after the step (S5) of forming the pores, (S6) a step of enlarging the pores inside the hollow fiber and newly forming pores outside the hollow fiber by drawing the PVDF hollow fiber membrane precursor.

In the step of preparing the pellet, an inorganic particle such as hydrophobic silica may not be used. Accordingly, production cost may be reduced and a process for removing an inorganic particle from the final PVDF hollow fiber membrane may be omitted. The step (S1) of preparing the pellet may include a step of performing spinning after mixing the PVDF and the diluent in the batch reactor at a first temperature for a first time, a step of cooling a thread formed in the spinning step in a solidification tank filled with a cooling medium, a step of drawing the cooled thread using a drawer and a step of pelletizing the drawn thread using a pelletizer.

The number of the batch reactor may be plural, the PVDF resin and the diluent (hereinafter, referred to “raw materials” of the mixture) may be supplied to the plural batch reactors simultaneously or sequentially and the spinning may be performed alternately in the plural batch reactors so that the spinning can be performed continuously. Specifically, (i) when a first batch reactor among the plural batch reactors performs spinning operation after mixing operation, the remaining batch reactors continue to perform mixing operation. Then, (ii) when the raw materials are depleted in the first batch reactor, spinning operation in the first batch reactor is stopped and mixing operation is performed again after supplying raw materials and a second batch reactor among the remaining batch reactors performs spinning operation from the time when the spinning operation by the first batch reactor is stopped, so that the spinning can be performed continuously.

Each of the plural batch reactors may be equipped with a stirrer. The stirrer may be operated during mixing operation and may be stopped during spinning operation. The stirrer may be equipped with, for example, a helical band type blade.

The first temperature may be 140-200° C. and the first time may be 2-6 hours. When the first temperature and the first time are within these ranges, the raw materials may be mixed completely and uniformly to be suitable for use as a pellet for preparation of a PVDF hollow fiber and the diluent included in the PVDF hollow fiber membrane precursor may cause cracks during drawing of the PVDF hollow fiber membrane precursor. As a result, a porous PVDF hollow fiber membrane or a PVDF hollow fiber membrane may be obtained finally. Because the PVDF-based resin and the diluent are sufficiently stirred and mixed in the batch reactor, the method of the present disclosure is applicable not only to a twin-screw extruder, which is advantageous in kneading, but also to a single-screw extruder.

The diluent mixed when preparing the pellet may be one or more selected from a group consisting of an acetate-based compound, a phthalate-based compound, a carbonate-based compound or a polyester-based compound. More specifically, it may be at least one selected from a group consisting of dibutyl phthalate (DBP), diethyl phthalate (DEP) and dimethyl phthalate (DMP). The cooling medium used when preparing the pellet is not particularly limited as long as it does not dissolve the PVDF and the diluent. For example, it may be water.

In the step (S4) of inducing the thermally induced phase separation, the thermally induced phase separation is induced by providing temperature difference between the inner and outer surfaces of the spun unsolidified PVDF hollow fiber by supplying nitrogen gas at higher temperature than the outer surface to the inner surface and quenching the outer surface using a cooling medium at lower temperature than the inner surface. The outer surface of the spun unsolidified PVDF hollow fiber may be cooled by gas cooling, liquid cooling or a combination thereof. More specifically, a volatile liquid having a low boiling point may be used. The low-boiling point liquid that may be used in the present disclosure may be an organic solvent having a boiling point of 30-80° C. Specifically, methanol, ethanol, acetone, methyl ethyl ketone, ethyl formate, carbon tetrachloride, Freon, etc. may be used.

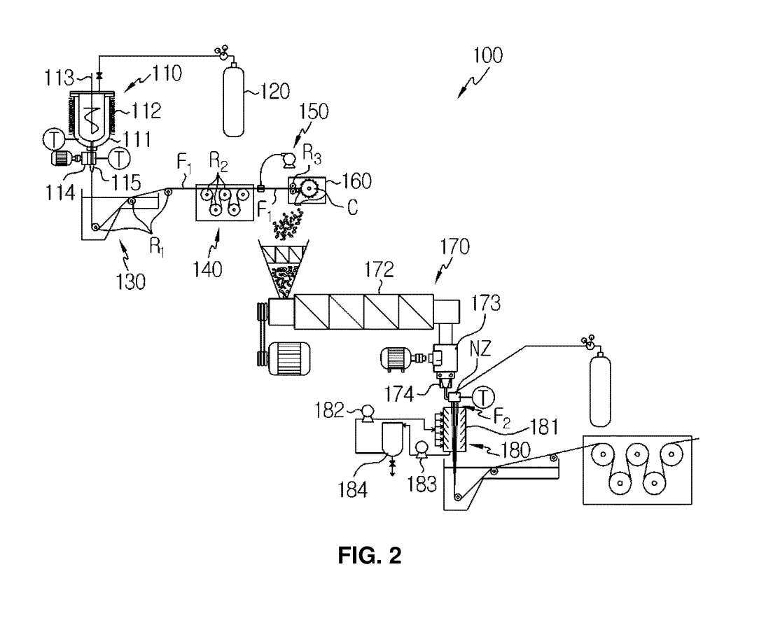

Hereinafter, the step (S1) of preparing the pellet through the step (S3) of forming the unsolidified PVDF hollow fiber are described in detail referring to FIG. 2. FIG. 2 shows an exemplary apparatus for manufacturing a PVDF hollow fiber membrane 100. Referring to FIG. 2, PVDF and a diluent in powder form are supplied together into a batch reactor 110. Although the apparatus for manufacturing a PVDF hollow fiber membrane 100 shown in FIG. 2 has only one batch reactor 110, the present disclosure is not limited thereto and two or more batch reactors may be equipped. The batch reactor 110 may be equipped with a dual jacket type main body 111, a heater 112 and a stirrer 113. The batch reactor 110 may be maintained with an inert atmosphere by connecting to a gas storage tank 120 containing, e.g., nitrogen gas. In the batch reactor 110, the PVDF (not shown) and the diluent (not shown) are uniformly mixed by heating and stirring (“mixing operation”). After sufficient mixing, the mixture is quantitatively ejected by a gear pump 114 and spun in a solidification tank 130 filled with a cooling medium after passing through a nozzle 115 (“spinning operation”). A thread F₁ is formed by the spinning. The thread F₁ is transferred from the solidification tank 130 to a drawer 140 by the action of a roller R₂ equipped at the drawer 140 passing through a roller R₁ equipped at the solidification tank 130 and then supplied to a pelletizer 160. The thread F₁ supplied to the pelletizer 160 passes through the roller R₃ and then cut by a cutter C to form a pellet P in the form of grains. The pellet P is supplied to an extruder 170 and then melted and spun to form a PVDF hollow fiber membrane precursor F₂. Specifically, the pellet P is supplied by a hopper 171 to an extrusion cylinder 172, melted to form a melt and then quantitatively supplied by a gear pump 173 to a spinneret 174. A dual spinning nozzle NZ is equipped at the outlet of the spinneret 174. The melt of the pellet P is spun while continuously supplying nitrogen gas at high temperature into the dual spinning nozzle NZ. As a result, the PVDF hollow fiber membrane precursor F₂ is formed.

The pellets P having different thermal histories due to the difference in retention time in the batch reactor 110 before the pelletizing have the same thermal history as they pass through the extruder 170. The unsolidified PVDF hollow fiber F₂ spun from the dual spinning nozzle NZ is cooled in the following cooling process. The PVDF hollow fiber membrane precursor F₂ formed through the above-described steps does not have pores but has sites (i.e., diluent sites) at which pores can be formed through the following drawing and extraction processes. In this regard, the method for manufacturing a PVDF hollow fiber membrane according to an exemplary embodiment of the present disclosure is distinguished from the existing thermally induced phase separation method whereby pores are formed by retaining a mixture of PVDF, a diluent and an inorganic particle for sufficient time under a phase separation condition.

Meanwhile, the previous efforts for manufacturing a PVDF hollow fiber membrane precursor by supplying PVDF and a diluent directly to an extruder without using an inorganic particle have not been successful due to separation of the PVDF and the diluent because it was difficult to ensure retention time for sufficient mixing of the PVDF and the diluent.

Next, the step (S4) of inducing the thermally induced phase separation is described in detail. While hot nitrogen gas is continuously supplied to the inner surface of the hollow fiber through the dual spinning nozzle NZ, air at low temperature or a low-boiling point solvent having a low boiling point is sprayed specifically in a co-current flow to the outer surface of the hollow fiber. That is to say, in the present disclosure, during the process in which the hollow fiber is cooled, the cooling rate at the outer and inner surfaces of the hollow fiber are controlled differently by blowing the air at low temperature or the low-boiling point solvent to the outer surface side of the hollow fiber which is spun in the cooling chamber 180 through the fine nozzle. As the cooling rate is controlled as described above, an asymmetric hollow fiber membrane having different pore sizes inside and outside is obtained.

In the present disclosure, a baffle 181 is equipped at the cooling chamber 180 to spray the low-boiling point solvent as fine liquid particles during the cooling process. In the apparatus shown in FIG. 2, the liquid cooling medium sprayed by the supply pump 182 into the cooling chamber 180 is evaporated as it takes heat from the hollow fiber and then recycled to a condenser 184 (wherein cooling water is circulating, although not shown) by a suction pump 183. The cooling medium condensed by the condenser 184 is supplied again to the cooling chamber 180 by the supply pump 182.

In accordance with the present disclosure, because the low-boiling point solvent in liquid state has very good cooling efficiency, a uniform hollow fiber can be manufactured stably even when it is supplied at a low flow rate of about 0.1-3 m/s and the low-boiling point solvent may be supplied directly from a separate storage tank without using a condenser.

As a result, the outer surface of the spun unsolidified PVDF hollow fiber is cooled rapidly and the remaining portion except the outer surface is cooled slowly. Specifically, as the outer surface of the spun unsolidified PVDF hollow fiber is cooled rapidly, the phase separation of the PVDF and the diluent is prevented and a non-porous structure, i.e., a dense structure, is obtained. On the other hand, at the remaining portion except the outer surface, i.e., the inner region, the phase separation of the PVDF and the diluent is facilitated due to the supply of nitrogen gas at higher temperature than the outer surface and a region with a porous structure is formed. As a result, an asymmetric PVDF hollow fiber membrane having different pore sizes on the inner and outer surfaces can be obtained.

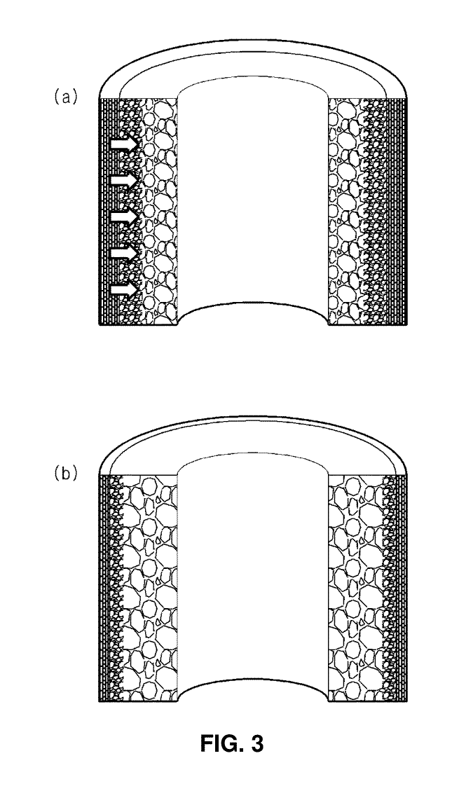

As seen from FIG. 3, the inner region is enlarged due to, for example, association of the diluent caused by liquid-liquid phase separation because the inside of the hollow fiber is still hot even after the spinning because of the supply of nitrogen gas. Meanwhile, at the outer surface of the hollow fiber which is in direct contact with the cooling medium, pore growth due to phase separation region is prevented. Owing to the migration, absorption and association of the diluent into the still hot inner region, the inside diluent region is expanded. On the outer surface where only the PVDF dominates, appreciable pores are not formed during extraction of the diluent and a dense structure is formed. In the contrast, a highly porous structure is formed inside as the diluent is removed by the extraction.

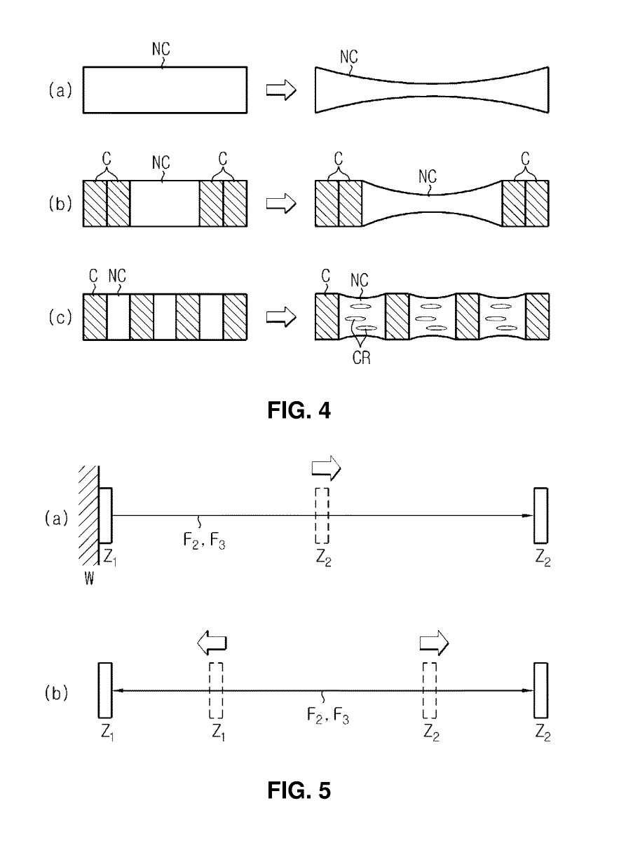

In the extraction process, only the diluent is extracted from the mixture of the PVDF and the diluent. Accordingly, an extraction solvent used in the process should lack compatibility with the PVDF, be easily compatible with the diluent and be easily removed. Because dimethyl phthalate (DMP), diethyl phthalate (DEP), dibutyl phthalate (DBP), etc. used as the diluent in the present disclosure can be extracted easily with an alcohol and the alcohol is also easily evaporated, methanol or ethanol may be used as the extraction solvent. Although pores of appreciable size are not formed on the outer dense region during the extraction process, cracking and pore formation occur in the following drawing process. As seen from (b) and (c) in FIG. 4, the thickness of the outer layer decreases during drawing (b). Cracking begins at a yield point and pores begin to grow (c). The PVDF hollow fiber may be drawn before or after the formation of pores by extracting the diluent. Specifically, the drawing may be performed after the extraction in the aspect of porosity.

The asymmetric PVDF hollow fiber membrane develops cracks during drawing not only in the inner region but also on part of the outer surface. As a result, an asymmetric PVDF hollow fiber membrane having small pore size and low porosity on the outer surface and large pore size and high porosity in the inner region is formed. Accordingly, a separation membrane (i.e., a hollow fiber membrane) manufactured using the PVDF hollow fiber membrane may have superior separation capability.

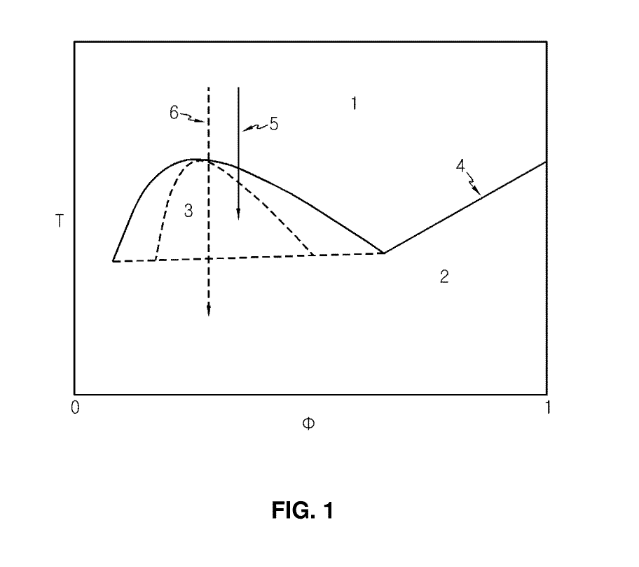

The phase separation occurring in the inner region and on the outer surface of the spun unsolidified PVDF hollow fiber is described in detail referring to FIG. 3. As seen from (a) of FIG. 3, on the outer surface of the hollow fiber, solid-liquid phase separation, thermally induced phase separation (TIPS) and crystallization are dominant due to the effect of quenching as shown in FIG. 1, resulting in the migration of the diluent. Inside the hollow fiber which is cooled slowly, growth occurs due to absorption and association of liquid drops.

DBP and DEP used as the diluent in the present disclosure have a solubility parameter (δ) of 20.2 and 20.5, respectively, whereas PVDF has a solubility parameter of 23.2. These diluents are mixed with the PVDF at high temperature. But, with the cooling, the DBP with a larger difference in the solubility parameter from the PVDF is phase-separated first and then the DEP is phase-separated. A non-porous outer surface layer having inappreciable pores is formed during the quenching as the DBP is phase-separated first, and then the inner porous structure is grown by to the DEP phase-separated later. Then, as seen from (b) of FIG. 3, as the outer surface layer of the hollow fiber becomes thinner during drawing, tensile strength increases due to crystal orientation and pores begin to form passing through the yield point as shown in (c) of FIG. 4. Meanwhile, on the inner surface of the hollow fiber, the space that has been occupied by the liquid drops is expanded during the drawing. This pore formation mechanism whereby different pores are formed inside and outside the hollow fiber is distinguished from the pore formation mechanism of the existing thermally induced phase separation method.

Now, the pore formation mechanism on the outer surface of the PVDF hollow fiber membrane precursor prepared by the process shown in FIG. 2 and a method for obtaining a PVDF hollow fiber membrane through drawing are described in detail referring to FIG. 4. FIG. 4 shows a phenomenon occurring when a solid obtained by melting and spinning a general polymer only is drawn. It is thought that the outer surface having a non-porous structure of the PVDF hollow fiber membrane precursor prepared by the process shown in FIG. 2 follows the mechanism shown in FIG. 4.

(a) of FIG. 4 shows drawing of a material consisting only of a non-crystallization region NC. When such a material is drawn, it is stretched without cracking and fails at the tensile strength limit. (b) of FIG. 4 shows drawing of a material consisting of a non-crystallization region NC and a crystallization region C. That is to say, it shows drawing of a material consisting of PVDF and a diluent which is not cracked during the drawing. When such a material is drawn, only the non-crystallization region NC is stretched without cracking and failure occurs at the tensile strength limit. (c) of FIG. 4 shows drawing of a material wherein a non-crystallization region NC and a crystallization region C are organically (e.g., alternatingly) and highly dispersed without discontinuities. When such a material is drawn, cracks CR begin to appear in the non-crystallization region NC as the yield point is passed and pores begin to grow.

The method for manufacturing a PVDF hollow fiber membrane according to an exemplary embodiment of the present disclosure includes the drawing process shown in (c) of FIG. 4. Accordingly, in the PVDF hollow fiber membrane obtained by the drawing, cracks are formed not only in the inner region but also in parts of the outer surface according to the mechanism illustrated in (c) of FIG. 4. Specifically, small pores appear on the outer surface of the PVDF hollow fiber membrane after the drawing and, in the inner region, the pores formed by the thermally induced phase separation described above grow further to large-sized pores. Accordingly, the finally obtained PVDF hollow fiber membrane, wherein the outer surface has small pore size and low porosity and the inner region has large pore size and high porosity, may have superior separation capability. Although the PVDF hollow fiber membrane precursor is stretched by the drawing, its thickness does not decrease significantly because the pores that grow in size during the drawing fill the inner space. Accordingly, in accordance with the method for manufacturing a PVDF hollow fiber membrane according to an exemplary embodiment of the present disclosure, manufacturing cost per unit membrane area may be reduced.

Meanwhile, as a result of the drawing in the present disclosure, tensile strength is increased and water permeability is increased significantly due to the orientation of polymer chains on the outer surface of the PVDF hollow fiber membrane precursor. In contrast, a separation membrane manufactured by the existing thermally induced phase separation (TIPS) method exhibits increased water permeability due to increased pore size during the drawing but does not show increase in tensile strength. Also, a separation membrane manufactured by the existing nonsolvent induced phase separation (NIPS) method shows slight increase in tensile strength after the drawing but does not show formation of new pores or increase in water permeability.

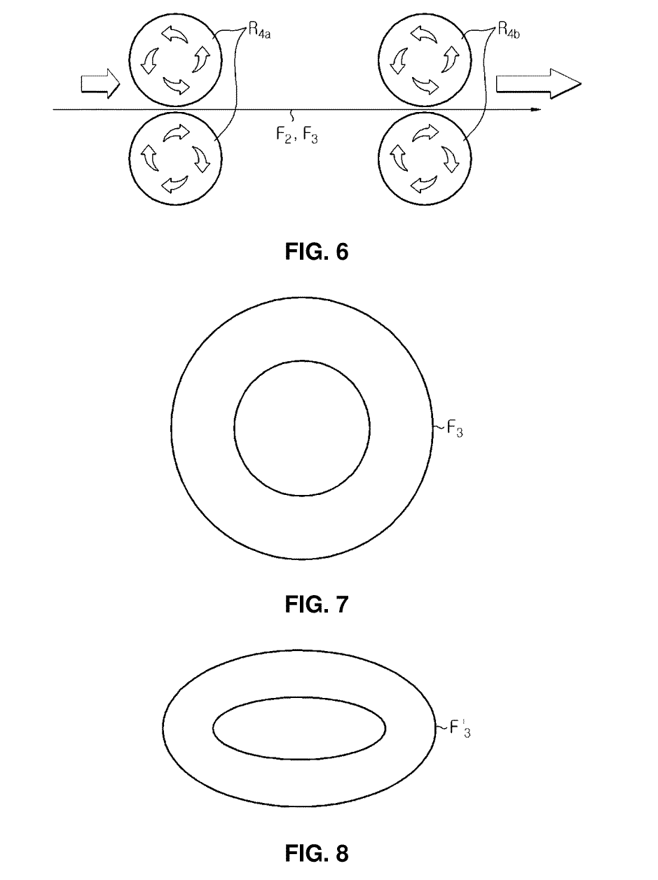

Hereinafter, the drawing method is described in detail referring to FIGS. 5-10. FIG. 5 is a schematic diagram for describing a batch jig drawing method. In the present disclosure, the “batch jig drawing method” refers to a method of fixing the PVDF hollow fiber membrane precursor with a pair of jigs and drawing the PVDF hollow fiber membrane precursor by moving one of the pair of jigs or both of them so that the distance between the jigs is increased. (a) of FIG. 5 shows a method of manufacturing a PVDF hollow fiber membrane F₃ by fixing a jig Z₁ to a wall W and drawing a PVDF hollow fiber membrane precursor F₂ by moving a jig Z₂ in a direction away from the jig Z₁. (b) of FIG. 5 shows a method of manufacturing the PVDF hollow fiber membrane F₃ by drawing the PVDF hollow fiber membrane precursor F₂ by moving the jig Z₁ and the jig Z₂ such that the distance between them is increased. The batch jig drawing method is advantageous in that there is no compression in the thickness direction as shown in FIG. 6, there is no damage to the outer surface and the PVDF hollow fiber membrane F₃ that can be bundled easily is obtained. However, the batch jig drawing method is disadvantageous in that continuous operation is impossible.

FIG. 6 is a schematic diagram for describing a continuous roller drawing method. In the present disclosure, the “continuous roller drawing method” refers to a method of drawing a PVDF hollow fiber membrane precursor by passing through two pairs of rollers rotating at different speeds. Referring to FIG. 6, a PVDF hollow fiber membrane F₃ is manufactured by drawing a PVDF hollow fiber membrane precursor F₂ by passing it through a pair of front rollers R₄ₐ and then through pair of rear rollers R_{4b} rotating at higher speeds than the pair of front rollers R₄ₐ. The continuous roller drawing method is advantageous in that the same deformation rate can be provided to the PVDF hollow fiber membrane precursor F₂, the associated facility is simple and continuous operation is possible. However, the continuous roller drawing method is disadvantageous in that compression occurs in the thickness direction as shown in FIG. 8 and the outer surface is damaged (scratched or worn) due to the contact with the rollers.

In the drawing step, the drawing rate may be 300 mm/min or lower. When the drawing rate is within this range, failure does not occur because tensile force is applied uniformly to the entire PVDF hollow fiber membrane precursor F₂. In the drawing step, the drawing temperature may be 25-35° C. When the drawing temperature is within this range, uniform drawing is possible and failure does not occur.

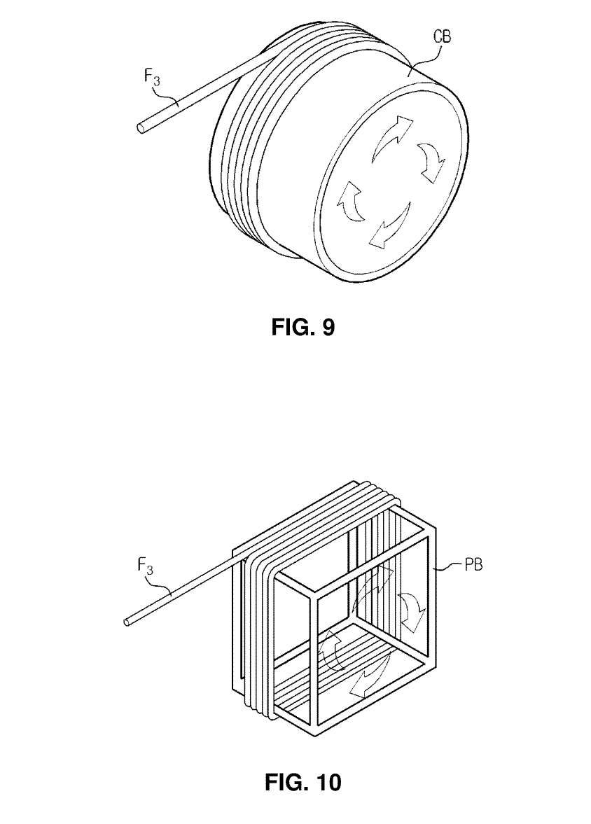

The method for manufacturing a PVDF hollow fiber membrane may further include (S7) a step of winding the PVDF hollow fiber membrane precursor or the PVDF hollow fiber membrane. The winding step (S7) may be performed after the step (S4) of inducing the thermally induced phase separation or after the drawing step (S6). The winding step (S7) may be performed by winding the PVDF hollow fiber membrane precursor or the PVDF hollow fiber membrane around a polyhedral bobbin. When the winding is performed using the polyhedral bobbin, compression does not occur because the PVDF hollow fiber membrane precursor or the PVDF hollow fiber membrane contacts only with the edge portion of the polyhedral bobbin and a process of unwinding the PVDF hollow fiber membrane precursor or the PVDF hollow fiber membrane from the polyhedral bobbin for the following process is unnecessary. If the polyhedral bobbin is used, compression does not occur even when the PVDF hollow fiber membrane precursor or the PVDF hollow fiber membrane is wound as multiple layers. For example, the polyhedral bobbin may be a hexahedral bobbin, although not being limited thereto. FIG. 10 shows the PVDF hollow fiber membrane F₃ wound around a hexahedral bobbin PB. Although not shown in the drawing, the PVDF hollow fiber membrane precursor F₂ may also be wound around the hexahedral bobbin PB. If the PVDF hollow fiber membrane F₃ is cut at each edge portion of the hexahedral bobbin PB, a bundling operation (a process of binding the PVDF hollow fiber membrane into a bundle) becomes easy. Meanwhile, if the PVDF hollow fiber membrane precursor F₂ is cut at each edge portion of the hexahedral bobbin PB, the following extraction process can be performed without a process of unwinding the PVDF hollow fiber membrane precursor F₂ from the hexahedral bobbin. If the PVDF hollow fiber membrane F₃ or the PVDF hollow fiber membrane precursor F₂ is wound using a cylindrical bobbin CB as shown in FIG. 9, compression of the PVDF hollow fiber membrane F₃ or the PVDF hollow fiber membrane precursor F₂ occurs because it is in contact with the surface of the cylindrical bobbin CB. To reduce the compression, the PVDF hollow fiber membrane F₃ or the PVDF hollow fiber membrane precursor F₂ should be wound as a single layer. In addition, a process of unwinding the PVDF hollow fiber membrane F₃ or the PVDF hollow fiber membrane precursor F₂ from the cylindrical bobbin CB is necessary for the following process and a separate bundling process is also necessary.

The method for manufacturing a PVDF hollow fiber membrane according to an exemplary embodiment of the present disclosure may further include (S8) a step of extracting the diluent from the wound PVDF hollow fiber membrane precursor or PVDF hollow fiber membrane by a solvent extraction method and drying a solvent remaining in the PVDF hollow fiber membrane precursor or PVDF hollow fiber membrane. The solvent used in the solvent extraction method (i.e., an extraction solvent) may be one which dissolves the diluent but does not dissolve the PVDF. For example, the solvent may be an alcohol such as methanol or ethanol, although not being limited thereto.

The method for manufacturing a PVDF hollow fiber membrane according to an exemplary embodiment of the present disclosure may include the step (S1) of preparing the pellet, the step (S2) of preparing the melted mixture, the step (S3) of forming the unsolidified PVDF hollow fiber, the step (S4) of inducing the thermally induced phase separation, the step (S5) of forming the pores, the drawing step (S6), the winding step (S7), the extraction and drying step (S8), the bundling step (S9) and a modularization step (S10). However, the present disclosure is not limited thereto. In the present disclosure, the “modularization step” refers to a step of fixing the PVDF hollow fiber membrane bundle bound in the bundling step in a module case using an adhesive.

In the present disclosure, unlike the existing TIPS and NIPS methods, the phase separation of the PVDF and the diluent is induced by the thermally induced phase separation method by providing temperature difference between the inner and outer surfaces of the hollow fiber during spinning and, as a result, an asymmetric structure in which the inner surface side and the outer surface side of the hollow fiber have different pore sizes and distributions is achieved. In addition, because no inorganic fine powder is included, high tensile strength and water permeability are achieved even after extraction and drawing processes as compared to the existing hollow fiber membrane due to large average pore size. The effect of water permeability and tensile strength depending on drawing ratio is described using an exemplary embodiment of the present disclosure.

In accordance with an exemplary embodiment of the present disclosure, after 0, 20, 40, 60, 80 and 100% drawing of a PVDF hollow fiber membrane precursor, water permeability and tensile strength of the obtained PVDF hollow fiber membrane were measured as shown in Table 4. The result is also graphically shown in FIG. 14. As can be seen from FIG. 14, the tensile strength of the hollow fiber membrane increased and the water permeability increased remarkably with the increasing drawing ratio due to the orientation of the polymer chains on the outer surface of the PVDF hollow fiber membrane precursor.

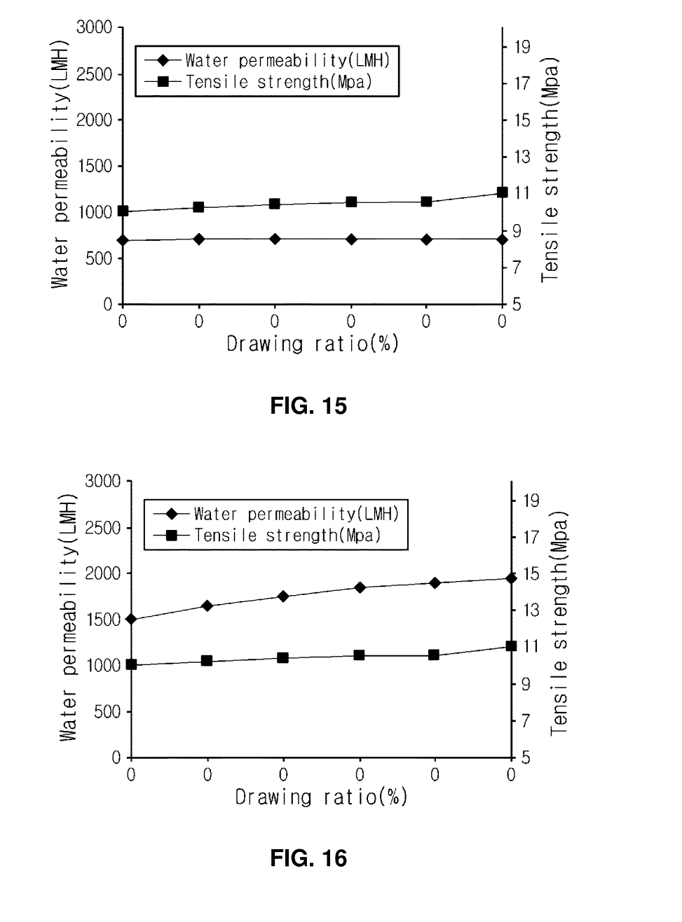

For comparison, a separation membrane precursor was prepared by the existing nonsolvent induced phase separation (NIPS) method and water permeability and tensile strength membrane of the obtained PVDF hollow fiber membrane were measured after 0, 20, 40, 60, 80 and 100% drawing as shown in Table 5. The result is also graphically shown in FIG. 15. As can be seen from FIG. 15, the PVDF hollow fiber membrane manufactured by the existing nonsolvent induced phase separation method showed no difference in tensile strength depending on drawing ratio and the water permeability did not increase significantly either.

Also, a separation membrane precursor was prepared by the existing thermally induced phase separation (TIPS) method and water permeability and tensile strength membrane of the obtained PVDF hollow fiber membrane were measured after 0, 20, 40, 60, 80 and 100% drawing as shown in Table 6. The result is also graphically shown in FIG. 16. As can be seen from FIG. 16, the PVDF hollow fiber membrane manufactured by the existing thermally induced phase separation method showed slight increase in water permeability depending on drawing ratio but no significant difference in tensile strength.

In accordance with the present disclosure, an asymmetric structure in which the inner surface side and the outer surface side of the hollow fiber have different pore sizes and distributions is achieved. This symmetric distribution of pores is described in further detail using a pore symmetry index.

The pore symmetry index of a separation membrane is defined as the ratio the pore area on the outer surface and the pore area on the inner surface as in the following equation. The value approaches 1 for a symmetric structure and approaches 0 for an asymmetric structure.

Pore symmetry index=(Pore area on outer surface)/(Pore area on inner surface).

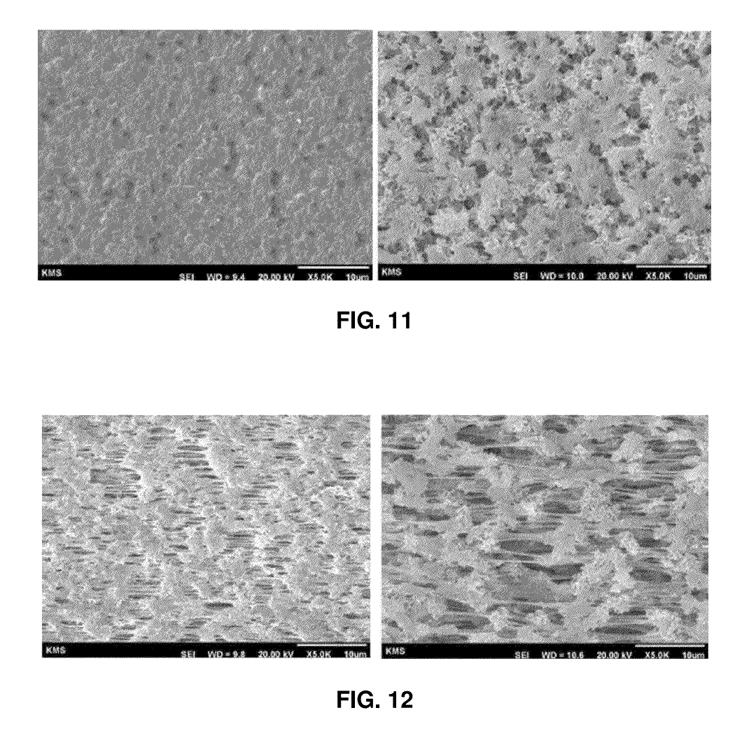

Before drawing, a hollow fiber membrane in according to an exemplary embodiment of the present disclosure had a perfectly asymmetric structure with round inner pores of an average diameter of 1.9 μm and outer pores of an average diameter of 0 μm, as shown in FIG. 11. After drawing, it had an asymmetric structure with a pore symmetry index of 0.27, with slit-shaped inner pores of an average major axis of 9.05 μm and an average minor axis of 2.15 μm and outer pores of an average major axis of 4.57 μm and an average minor axis 1.14 μm, as shown in FIG. 12.

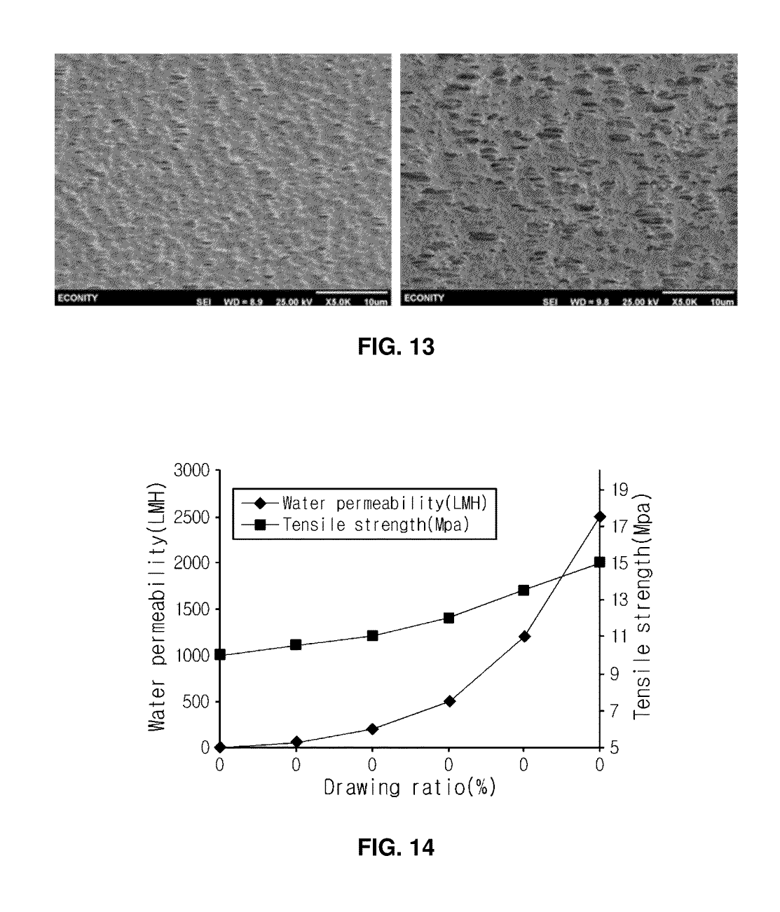

A hollow fiber membrane according to another exemplary embodiment of the present disclosure with different compositions of PVDF and a plasticizer had a pore symmetry index of 0.17 after drawing, with slit-shaped inner pores of an average major axis of 4.14 μm and an average minor axis of 1.12 μm and outer pores of an average major axis of 2.22 μm and an average minor axis of 0.36 μm, as shown in FIG. 13.

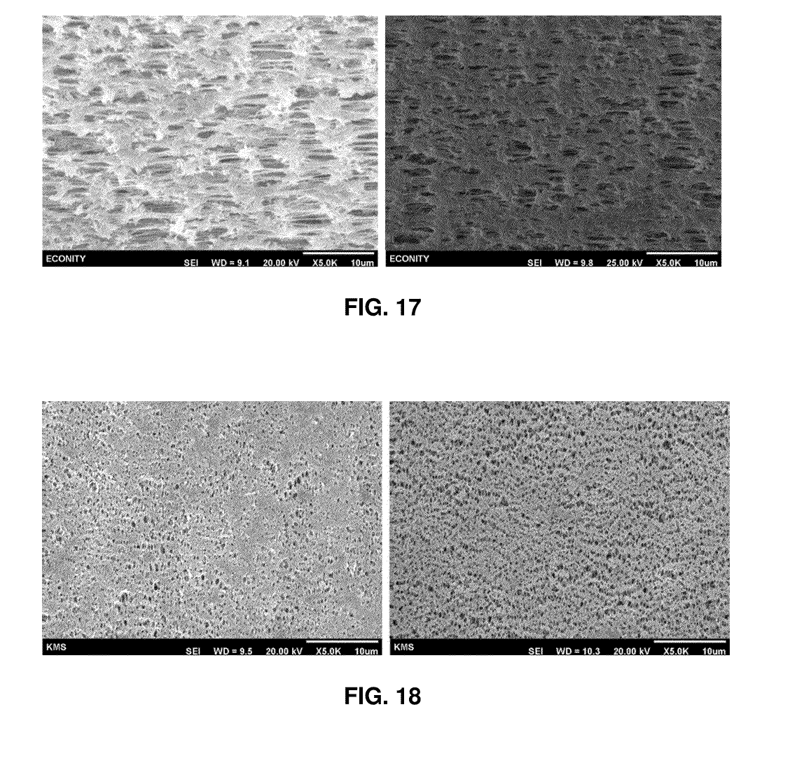

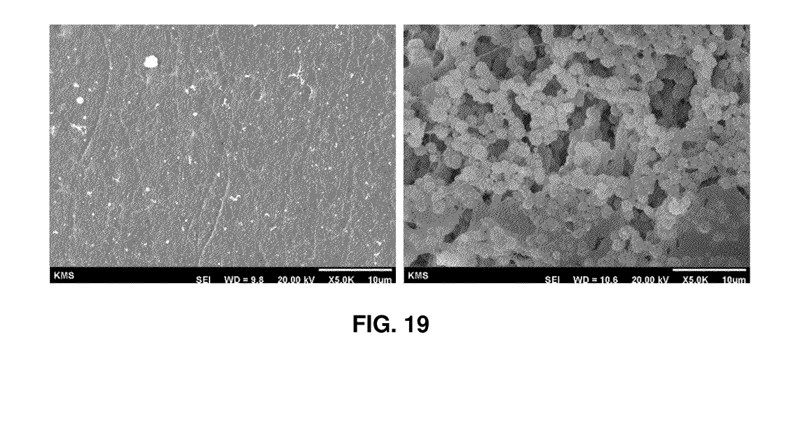

A hollow fiber membrane according to another exemplary embodiment of the present disclosure, wherein the content of DEP in a plasticizer was larger than that of DBP and a solidification tank at 60° C. was used, had a pore symmetry index of 0.75 after drawing, with slit-shaped inner pores of an average major axis of 9.1 μm and an average minor axis of 2.2 μm and outer pores of an average major axis of 8.4 μm and an average minor axis of 1.8 μm, as shown in FIG. 17.

In contrast, an Asahi Kasei's separation membrane manufactured by the existing TIPS method did not have slit-shaped pores due to the absence of the pore formation by drawing and its pore symmetry index was calculated to be 0.92 with an average major axis of 1.3 μm and average minor axis of 0.8 μm on the inner surface and an average major axis of 1.2 μm and an average minor axis 0.8 μm, as shown in FIG. 18. A Toray's separation membrane manufactured by the existing NIPS method also did not have slit-shaped pores due to the absence of the pore formation by drawing and its pore symmetry index was 0 because there was a dense skin layer formed by NIPS on the outside, as shown in FIG. 18.

Unlike the separation membranes manufactured by the existing TIPS and NIPS methods, the asymmetric PVDF hollow fiber membrane manufactured by the method of the present disclosure has a pore symmetry index, defined as the ratio the pore area on the outer surface and the pore area on the inner surface, of 0.1-0.8. Such a pore symmetry index is achieved through control of the contents of the PVDF and the plasticizer, the temperature of the solidification tank and the drawing ratio. The asymmetric PVDF hollow fiber membrane manufactured according to the present disclosure, which has a pore symmetry index of 0.1-0.8, has remarkable water permeability and superior tensile strength unlike the PVDF separation membranes manufactured by the existing TIPS and NIPS methods. Also, it may have superior separation capability because the outer surface has small pores and low porosity and the inner region has large pores and high porosity.

### EXAMPLES

Hereinafter, the present disclosure is described in further detail with examples. However, the present disclosure is not limited by these examples.

### Example 1

### Manufacturing of PVDF Hollow Fiber Membrane

A PVDF hollow fiber membrane precursor was prepared using an apparatus shown in FIG. 2. The prepared PVDF hollow fiber membrane precursor was wound around a rectangular parallelepiped bobbin. Then, the wound PVDF hollow fiber membrane precursor was cut at the edge portion of the rectangular parallelepiped bobbin, and a diluent was extracted from the cut PVDF hollow fiber membrane precursor by a solvent extraction method using ethanol as an extraction solvent. After drying at 50° C. for 2 hours, the PVDF hollow fiber membrane precursor was drawn by 125% by a batch jig drawing method as shown in (a) of FIG. 5. Thus obtained PVDF hollow fiber membrane was heat-treated in tensed state if necessary. Details of the associated apparatus, operation condition and composition of raw materials are described in Table 1 and Table 2.

TABLE 1

| Apparatus | Operation condition |
|---|---|
| Batch reactor | Mixing at 150° C. for 2 hours |
| Gear pump | Ejection at 17 mL/min |
| Solidification tank | Water at 15° C. was used as cooling medium |
| Drawer | Drawing at a rate of 11 m/min |
| Pelletizer | Cutting to a size of 3 mm |
| Extruder | Ejection at 150° C. and 17 mL/min |
| Batch jig | Drawing at a rate of 300 m/min |

TABLE 2
Composition of raw materials (parts by weight)

| | |
|---|---|
| PVDF | 36 |
| DBP | 44.8 |
| DEP | |

### Comparative Example 1

### Manufacturing of PVDF Hollow Fiber Membrane

A PVDF hollow fiber membrane was manufactured in the same manner as in Example 1 except that a PVDF hollow fiber membrane precursor was prepared by supplying PVDF, DBP and DEP directly to the extruder without pelletizing (i.e., without passing through the batch reactor and the pelletizer).

A PVDF hollow fiber membrane was manufactured in the same manner as in Example 1 except for the drawing.

### Comparative Example 2

### Manufacturing of PVDF Hollow Fiber Membrane

A PVDF hollow fiber membrane was manufactured in the same manner as in Example 1 except the drawing ratio was 40%.

### Comparative Example 3

### Manufacturing of PVDF Hollow Fiber Membrane

A PVDF hollow fiber membrane was manufactured in the same manner as in Example 1 except the drawing ratio was 80%.

### Evaluation Examples

### Evaluation Example 1

### Evaluation of Surface of PVDF Hollow Fiber Membrane Precursor

Scanning electron micrographic (SEM) images (SAERON, AIS2100) of the outer surface and the inner surface of the PVDF hollow fiber membrane precursor prepared in Example 1 are shown in FIG. 11. In FIG. 11, the left SEM image is that of the outer surface and the right SEM image is that of the inner surface. From FIG. 11, it can be seen that the outer surface of the PVDF hollow fiber membrane precursor prepared in Example 1 is in the form of a dense membrane because liquid-liquid phase separation did not occur due to quenching, whereas the slowly cooled inner surface is in the form of a porous membrane due to liquid-liquid phase separation. Accordingly, it was confirmed that the PVDF hollow fiber membrane precursor prepared in Example 1 has an asymmetric structure.

### Evaluation Example 2

### Evaluation of Surface of PVDF Hollow Fiber Membrane

Scanning electron micrographic images (SAERON, AIS2100) of the outer surface and the inner surface of the PVDF hollow fiber membrane manufactured from the PVDF hollow fiber membrane precursor prepared in Example 1 through diluent extraction and drawing are shown in FIG. 12. In FIG. 12, the left SEM image is that of the outer surface and the right SEM image is that of the inner surface. From FIG. 12, it can be seen that whereas the outer surface of the PVDF hollow fiber membrane manufactured in Example 1 has a porous structure with small pores and low porosity, the inner surface has a porous structure with large pores and high porosity. Accordingly, it was confirmed that the PVDF hollow fiber membrane manufactured in Example 1 has an asymmetric structure.

### Evaluation Example 3

### Evaluation of Physical Properties of PVDF Hollow Fiber Membrane

The tensile strength, average pore size, porosity and water permeability of the PVDF hollow fiber membranes manufactured in Example 1 and Comparative Example 1 were measured as described below. The result is shown in Table 3.

(Measurement of Tensile Strength)

Tensile strength was measured according to ASTM D2256.

(Measurement of Average Pore Size and Porosity)

Average pore size and porosity were measured as follows. After obtaining the SEM images of the surface of the PVDF hollow fiber membrane using a scanning electron microscope (FE-SEM, Carl Zeiss Supra 55), average pore size was determined by measuring the average length of the major axis and minor axis of the pores from the SEM images using an image analyzer (Image-Pro Plus). Also, porosity was determined by measuring the ratio of the apparent area of the surface of the PVDF hollow fiber membrane to the pore area using the image analyzer.

(Measurement of Water Permeability)

Permeability was measured according to KS K3100. After measuring membrane area based on the outer diameter of the hollow fiber membrane (the outer diameter surface area of the hollow fiber membrane was summed), the flow rate of pure water at 25° C. passing through the hollow fiber membrane from outside to inside under a pressure of 100 kPa per unit time and unit membrane area was measured.

TABLE 3

| | Tensile | | | Water |
|---|---|---|---|---|
| | strength | Average pore | Porosity | permeability |
| | (MPa) | size (μm) | (%) | (LMH, L/m²hr) |
| Example 1 | 15 | 0.12 | 80 | 2500 |
| Comparative | 10 | 0.05 | 60 | 0 |
| Example 1 | | | | |
| Comparative | 11 | 0.08 | 65 | 200 |
| Example 2 | | | | |
| Comparative | 13.5 | 0.1 | 70 | 1200 |
| Example 3 | | | | |

From Table 3, it can be seen that the PVDF hollow fiber membrane manufactured in Example 1 exhibits higher tensile strength, larger average pore size and higher porosity and water permeability than the PVDF hollow fiber membrane manufactured in Comparative Example 1.

### Example 2

### Evaluation of Performance and Physical Properties of PVDF Hollow Fiber Membrane Depending on Drawing Ratio

In Examples 2-1 to 2-6, a PVDF hollow fiber membrane precursor was prepared in the same manner as in Example 1 and PVDF hollow fiber membranes were obtained by drawing the PVDF hollow fiber membrane precursor 0, 20, 40, 60, 80 and 100% by the batch jig drawing method shown in (a) of FIG. 5. Water permeability and tensile strength depending on drawing ratio were measured under the same condition as in Evaluation Example 3. The result is shown in Table 4. The water permeability and tensile strength depending on drawing ratio are also graphically shown in FIG. 14.

From FIG. 14, it can be seen that the PVDF hollow fiber membranes according to the present disclosure exhibit increased tensile strength due to the orientation of polymer chains on the outer surface during drawing as well as remarkably increased water permeability.

TABLE 4

| | Drawing | Water | Tensile |
|---|---|---|---|
| | ratio | permeability | strength |
| | (%) | (LMH, L/m²hr) | (MPa) |
| Example 2-1 | 0 | 0 | 10 |
| Example 2-2 | 20 | 50 | 10.5 |
| Example 2-3 | 40 | 200 | 11 |
| Example 2-4 | 60 | 500 | 12 |
| Example 2-5 | 80 | 1200 | 13.5 |
| Example 2-6 | 100 | 2500 | 15 |

In Comparative Examples 4-1 to 4-6, PVDF hollow fiber membranes were obtained by drawing a separation membrane manufactured by the existing nonsolvent induced phase separation (NIPS) method 0, 20, 40, 60, 80 and 100%. Water permeability and tensile strength depending on drawing ratio were measured under the same condition as in Evaluation Example 3. The result is shown in Table 5. The water permeability and tensile strength depending on drawing ratio are also graphically shown in FIG. 15.

From FIG. 15, it can be seen that the PVDF hollow fiber membranes of Comparative Examples 4-1 to 4-6 show no difference in tensile strength depending on drawing ratio and show no significant increase in water permeability.

TABLE 5

| | Drawing | Water | Tensile |
|---|---|---|---|
| | ratio | permeability | strength |
| | (%) | (LMH, L/m²hr) | (MPa) |
| Comparative | 0 | 700 | 10 |
| Example 4-1 | | | |
| Comparative | 20 | 702 | 10.2 |
| Example 4-2 | | | |
| Comparative | 40 | 706 | 10.4 |
| Example 4-3 | | | |
| Comparative | 60 | 708 | 10.5 |
| Example 4-4 | | | |
| Comparative | 80 | 710 | 10.5 |
| Example 4-5 | | | |
| Comparative | 100 | 710 | 11 |
| Example 4-6 | | | |

In Comparative Examples 5-1 to 5-6, PVDF hollow fiber membranes were obtained by drawing a separation membrane manufactured by the existing thermally induced phase separation (TIPS) method 0, 20, 40, 60, 80 and 100%. Water permeability and tensile strength depending on drawing ratio were measured under the same condition as in Evaluation Example 3. The result is shown in Table 6. The water permeability and tensile strength depending on drawing ratio are also graphically shown in FIG. 16.

From FIG. 16, it can be seen that the PVDF hollow fiber membranes of Comparative Examples 5-1 to 5-6 show increase in water permeability depending but no significant difference in tensile strength.

TABLE 6

| | Drawing | Water | Tensile |
|---|---|---|---|
| | ratio | permeability | strength |
| | (%) | (LMH, L/m²hr) | (MPa) |
| Comparative | 0 | 1,500 | 10 |
| Example 5-1 | | | |
| Comparative | 20 | 1,650 | 10.2 |
| Example 5-2 | | | |
| Comparative | 40 | 1,750 | 10.4 |
| Example 5-3 | | | |
| Comparative | 60 | 1,850 | 10.5 |
| Example 5-4 | | | |
| Comparative | 80 | 1,900 | 10.5 |
| Example 5-5 | | | |
| Comparative | 100 | 1,950 | 11 |
| Example 5-6 | | | |

### Evaluation Example 4

### Pore Symmetry Index

The pore symmetry index of a separation membrane is defined as the ratio of the pore area on the outer surface and the pore area on the inner surface. The value approaches 1 for a symmetric structure and approaches 0 for an asymmetric structure.

Pore symmetry index=(Pore area on outer surface)/(Pore area on inner surface)

Before drawing, the hollow fiber membrane of Example 1 had a perfectly asymmetric structure with a pore symmetry index of 0, with round inner pores of an average diameter of 1.9 μm and outer pores of an average diameter of 0 μm, as shown in FIG. 11. After drawing, it had an asymmetric structure with a pore symmetry index of 0.27, with slit-shaped inner pores of an average major axis of 9.05 μm and an average minor axis of 2.15 μm and outer pores of an average major axis of 4.57 μm and an average minor axis 1.14 μm, as shown in FIG. 12.

Pore symmetry index=(π×4.57/2×1.14/2)/(π×9.05/2×2.15/2)=0.27

### Example 3

In Example 3, a hollow fiber membrane was manufacture in the same manner as in Example 1 with the composition of the raw materials described in Table 7.

TABLE 7
Composition of raw materials (parts by weight)

| | |
|---|---|
| PVDF | 37 |
| DBP | 44.1 |
| DEP | |

After drawing, the hollow fiber membrane had a pore symmetry index of 0.17, with slit-shaped inner pores of an average major axis of 4.14 μm and an average minor axis of 1.12 μm and outer pores of an average major axis of 2.22 μm and an average minor axis of 0.36 μm, as shown in FIG. 13.

Pore symmetry index=(π×2.22/2×0.36/2)/(π×4.14/2×1.12/2)=0.17

### Example 4

In Example 4, a hollow fiber membrane was manufacture in the same manner as in Example 1. The temperature of the solidification tank was 60° C. and the composition of the raw materials is described in Table 8.

TABLE 8
Composition of raw materials (parts by weight))

| | |
|---|---|
| PVDF | 36 |
| DBP | 19.2 |
| DEP | |

After drawing, the hollow fiber membrane had a pore symmetry index of 0.75, with slit-shaped inner pores of an average major axis of 9.1 μm and an average minor axis of 2.2 μm and outer pores of an average major axis of 8.4 μm and an average minor axis of 1.8 μm, as shown in FIG. 17.

Pore symmetry index=(π×8.4/2×1.8/2)/(π×9.1/2×2.2/2)=0.75

### Comparative Example 6

### Pore Symmetry Index of Separation Membrane Prepared by Existing TIPS Method

An Asahi Kasei's separation membrane manufactured by the existing TIPS method did not have slit-shaped pores due to the absence of the pore formation by drawing and its pore symmetry index was calculated to be 0.92 with an average major axis of 1.3 μm and average minor axis of 0.8 μm on the inner surface and an average major axis of 1.2 μm and an average minor axis 0.8 μm, as shown in FIG. 18.

Pore symmetry index=(π×1.2/2×0.8/2)/(π×1.3/2×0.8/2)=0.92

### Comparative Example 7

### Pore Symmetry Index of Separation Membrane Prepared by Existing NIPS Method

A Toray's separation membrane manufactured by the existing NIPS method also did not have slit-shaped pores due to the absence of the pore formation by drawing and its pore symmetry index was 0 because there was a dense skin layer formed by NIPS on the outside, as shown in FIG. 18.

The pore symmetry indices of the separation membranes of Examples 1, 3 and 4 and Comparative Examples 6 and 7 are summarized in Table 9.

TABLE 9

| | Pore symmetry index |
|---|---|
| Example 1 | 0.27 |
| Example 3 | 0.17 |
| Example 4 | 0.75 |
| Comparative | 0.92 |
| Example 6 | |
| Comparative | 0 |
| Example 7 | |

As described above, unlike the separation membranes manufactured by the existing TIPS and NIPS methods, the asymmetric PVDF hollow fiber membrane manufactured by the method of the present disclosure has a pore symmetry index, defined as the ratio of the pore area on the outer surface and the pore area on the inner surface, of 0.1-0.8 and thus exhibits remarkable water permeability and superior tensile strength distinguished from those of the PVDF separation membranes manufactured by the existing TIPS and NIPS methods.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### INDUSTRIAL APPLICABILITY

In accordance with the present disclosure, an asymmetric PVDF hollow fiber membrane with higher tensile strength, larger average pore size and higher porosity and water permeability than the existing hollow fiber membrane is manufactured by the thermally induced phase separation method, which enables effective mixing of the PVDF and a diluent without additional use of an inorganic fine powder such as silica and is advantageous in that it is relatively easy to control preparation parameters because temperature is the main factor of phase separation of the two-component system of the polymer and the diluent and thus to obtain a separation membrane of satisfactory quality. The asymmetric porous PVDF hollow fiber membrane having superior water permeability and physical properties is suitable for the treatment of dirty water, wastewater and sewage containing inorganic and/or organic materials. It is industrially applicable to water treatment because it is applicable to water treatment modules and methods.

1. A method for manufacturing an asymmetric PVDF hollow fiber membrane, comprising:
(a) preparing a melted mixture comprising a PVDF resin and a diluent;
(b) forming an unsolidified PVDF hollow fiber by spinning the melted mixture through a dual nozzle;
(c) inducing thermally induced phase separation by providing temperature difference between the inner and outer surfaces of the spun unsolidified PVDF hollow fiber by supplying nitrogen gas at higher temperature than the outer surface to the inner surface and quenching the outer surface using a cooling medium at lower temperature than the inner surface; and
(d) forming pores inside the hollow fiber by extracting the diluent from the thermally phase separation induced PVDF hollow fiber precursor.

2. The method for manufacturing an asymmetric PVDF hollow fiber membrane according to claim 1, wherein the preparing the melted mixture comprises preparing a pellet by uniformly mixing a PVDF resin and a diluent in a batch reactor and melting the prepared pellet in an extruder.

3. The method for manufacturing an asymmetric PVDF hollow fiber membrane according to claim 1, which further comprises, before or after the forming the pores, enlarging the pores inside the hollow fiber and newly forming pores outside the hollow fiber by drawing the PVDF hollow fiber membrane precursor.

4. The method for manufacturing an asymmetric PVDF hollow fiber membrane according to claim 1, wherein the diluent is selected from a group consisting of dibutyl phthalate (DBP), diethyl phthalate (DEP) and dimethyl phthalate (DMP).

5. The method for manufacturing an asymmetric PVDF hollow fiber membrane according to claim 3, wherein the drawing the PVDF hollow fiber membrane precursor is performed by a batch jig drawing method or a continuous roller drawing method.

6. The method for manufacturing an asymmetric PVDF hollow fiber membrane according to claim 2, wherein the preparing the pellet comprises:
performing spinning after mixing the PVDF and the diluent in the batch reactor at a first temperature for a first time;
cooling a thread formed by the spinning in a solidification tank filled with a cooling medium;
drawing the cooled thread using a drawer; and
pelletizing the drawn thread using a pelletizer.

7. The method for manufacturing an asymmetric PVDF hollow fiber membrane according to claim 2, wherein the number of the batch reactor is plural, the PVDF resin and the diluent are supplied to the plural batch reactors simultaneously or sequentially and the spinning is performed alternately in the plural batch reactors so that the spinning can be performed continuously.

8. The method for manufacturing an asymmetric PVDF hollow fiber membrane according to claim 6, wherein the first temperature is 140-200° C. and the first time is 2-6 hours.

9. The method for manufacturing an asymmetric PVDF hollow fiber membrane according to claim 7, wherein each of the plural batch reactors is equipped with a stirrer and the stirrer is operated during mixing operation and is stopped during spinning operation.

10. An asymmetric PVDF hollow fiber membrane manufactured by the method for manufacturing an asymmetric PVDF hollow fiber membrane according to claim 1, which has a pore symmetry index, defined as the ratio the pore area on the outer surface and the pore area on the inner surface, of 0.1-0.8.
